(19) United States
(12) Patent Application Publication
(10) Pub. No.: US 2011/0252840 A1
(43) Pub. Date: Oct. 20, 2011

(54) Entrance Door Security System

(76) Inventor: Robert E. Cutrer, Lake Jackson, TX (US)

(21) Appl. No.: 12/760,027

(22) Filed: Apr. 14, 2010

(51) Int. Cl. E05B 65/00; E05B 15/02

(52) U.S. Cl. 70/91

(57) ABSTRACT

A deadbolt reinforcement assembly and entrance door security system are provided, comprising a deadbolt reinforcement cylinder adapted to receive a deadbolt assembly within a deadbolt bore; a door reinforcement plate having opposing flanges extending over the interior face and exterior faces of the door; and door reinforcement bolts inserted through the door and establishing a secure fit between the opposing flanges. The bolts are secured by a threaded nut on the exterior face of the door with a smooth head to prevent disassembly from the exterior side. A reinforced deadbolt striker plate and security hinges are also provided, such that all weak areas of the door are more resistant to attempts to breach the door.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to entrance door security hardware, and more particularly to an improved door security hardware system, for preventing or delaying unauthorized intrusion.

2. Description of Related Art

Conventional door assemblies are comprised of a hinged door residing within a casing nailed to an interior wall structure. The door latch engages a striker plate which is typically attached to the casing by a pair of screws. If a dead bolt lock is also employed, the bolt engages its own striker plate attached to the casing in a similar manner as the door latch striker plate. In most conventional door assemblies, the casing is about ¾ inch thick, which means that the thin metal striker plate or the casing itself may not be sufficient to withstand an attempted forced entry.

Numerous designs have been proposed over the years which are directed to improving the strength of conventional door assemblies. One disadvantage of many designs is that they are intended for installation with original construction, i.e. when the home is being built, because the alternative hardware is easier to install when the interior wall structure is exposed. Another disadvantage is that many security hardware systems are bulky and unsuitable for home use where traditional trim molding and other decorative features are desired by the homeowner. A third disadvantage is that such security hardware may be difficult to install for the typical “do it yourself” homeowner.

Over the years, inventors have focused on one or two weak points in the door assembly, and such solutions are generally more effective than the conventional hardware. However, none of those solutions appears to accomplish the primary objective, which is to prevent the entrance door from being breached. For example, in U.S. Pat. No. 6,679,019 to Rochman, U.S. Pat. No. 5,269,100 to Fontenot, and in my prior patent, U.S. Pat. No. 7,520,544, none of those devices provide sufficient reinforcement in critical areas to be effective against the most common efforts to breach the door. Mechanical failure in response to breaching forces most often occurs in the deadbolt itself, the door in which it is installed, and the striker plate in which the deadbolt resides when locked.

With respect to Rochman, the reinforcement plate present in that assembly could not prevent the door from being breached for several reasons. First, the reinforcement plate only supports the inner portion of the door deadbolt bore, which only supports the linkage of the deadbolt mechanism. It cannot prevent the deadbolt from pivoting. Second, the reinforcement plate includes no support for the outer edges of the door, enabling the door to split or separate due to lack of support. Finally, the Rochman patent includes no support for the door casing on the latch side, or the hinge side, although both of these areas are subject to failure during an attempted breach.

With respect to Fontenot, that system does include a door reinforcement plate that wraps around the door itself. However, that assembly is insufficient to prevent the door from being breached for several reasons. First, the door reinforcement plate in Fontenot does not provide a close fit against the latch or deadbolt itself, and a breaching force would still allow the deadbolt to pivot within the softer wood in which it is installed. Second, the door reinforcement plate of Fontenot is inadequately anchored, being attached to the door only by short anchoring screws. These short screws are easily displaced during a strong breaching impact, and would allow the door edges to split, resulting in movement of the installed deadbolt away from its fully engaged position within the striker plate. Finally, although the Fontenot assembly includes an improved striker plate, that device is not sufficiently strong to resist a breaching force, because it is merely attached through the casing and the wall studs via conventional screws, and with no other metal plate as reinforcement.

Moreover, neither Fontenot or Rochman address the hinge side of the door assembly, leaving another conspicuous weak point in their respective systems. In contrast, my prior patents, U.S. Pat. No. 7,520,544 and U.S. Pat. No. 5,570,917, directly address the hinges as a weak area, and have provided a superior solution against breaching attempts on the hinge side of the door.

Despite the advantages and success of prior art designs, none of the above systems were designed to resolve all the weak points of the door system. Therefore, there is a need for a door security system which remains inexpensive, easy to install, and effective in withstanding the sudden and intense impact of a forced entry attempt.

### SUMMARY OF THE INVENTION

In a door having an end face, an exterior face, and an interior face, a deadbolt reinforcement assembly is provided, comprising a deadbolt reinforcement cylinder adapted to receive a deadbolt assembly, wherein the deadbolt reinforcement cylinder includes a face plate, wherein the deadbolt reinforcement cylinder is positioned within a deadbolt bore of the door, and wherein the face plate is secured to the door by a plurality of fasteners; a door reinforcement plate having a front plate with a deadbolt hole, and including a first flange extending from the front plate over the interior face of the door, and a second flange extending from the front plate over the exterior face of the door, wherein each of the first and second flanges includes a plurality of mounting holes; and one or more door reinforcement bolts, wherein each of the door reinforcement bolts is inserted through the mounting holes aligned between the first and second flanges and through a bolt hole formed in the door, and wherein each of the door reinforcement bolts is secured by a threaded nut.

In a preferred embodiment, the face plate of the deadbolt reinforcement cylinder includes face plate mounting holes aligned with mounting holes on the deadbolt assembly.

More preferably, the deadbolt hole of the door reinforcement plate is shaped and dimensioned to permit slidable passage of a deadbolt, but wherein the deadbolt hole is closely matched to the shape and size of the deadbolt.

Optionally, the front plate of the door reinforcement plate includes mounting holes aligned with mounting holes on the deadbolt assembly.

As an additional security measure, each of the door reinforcement bolts is inserted from the exterior side of the door, and wherein each of the bolts includes a smooth head to prevent disassembly from the exterior side of the door.

An entrance door security system is also provided, comprising a deadbolt reinforcement assembly as described above; and a deadbolt striker plate assembly comprising a deadbolt striker plate having a striker face plate and an enclosed housing adapted to receive a deadbolt from the deadbolt assembly, wherein the striker face plate is attached to a door casing by a second plurality of fasteners; and a reinforcing member comprising a first flange parallel to the striker face plate having an opening adapted to matably and interlockingly surround and engage the housing of the deadbolt striker plate, and a second flange perpendicular to the first flange having a first hole pattern, wherein the second flange of the reinforcing member is attached to a wall stud by a third plurality of fasteners.

In a preferred embodiment, the entrance door security system further includes at least one security hinge assembly connected between the door, the door casing and an interior wall structure, wherein the security hinge assembly comprises first and second hinging plates operatively connected by a pin, wherein the first hinging plate is attached to the door and includes a backstop plate; and wherein the second hinging plate includes an anchoring plate attached to the interior wall structure.

More preferably, the deadbolt striker plate assembly further includes a shim plate having a second hole pattern adapted to matably engage the first hole pattern of the second flange of the reinforcing member, and wherein the first hole pattern comprises at least two holes adapted to receive mounting screws.

### BRIEF DESCRIPTION OF THE DRAWINGS

For a further understanding of the nature, objects, and advantages of the present invention, reference should be made to the following detailed description, read in conjunction with the following drawings, wherein like reference numerals denote like elements.

FIG. 1 is a perspective view of the components of the deadbolt reinforcement assembly.

FIG. 2 is a perspective view of the components of the deadbolt striker plate assembly.

FIG. 3 is a perspective view of the security hinge assembly.

FIG. 4 is a view of a mounting screw.

FIG. 5 is an exploded view of the deadbolt reinforcement assembly.

FIG. 6 is a sectional view of a prior art conventionally installed deadbolt mechanism, depicting the deadbolt weak points which allows the deadbolt to pivot under impact forces.

FIG. 7 is a sectional view of the deadbolt mechanism with the deadbolt reinforcement cylinder.

FIG. 8 is a sectional view of the door reinforcement plate in an installed configuration.

FIG. 9 is a top view of the deadbolt reinforcement assembly, the deadbolt striker plate assembly, and the security hinge assembly in an installed configuration.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

Importantly, this invention builds upon the door security devices which are described in my two prior patents, U.S. Pat. No. 7,520,544 and U.S. Pat. No. 5,570,917. Therefore, those disclosures are hereby and expressly incorporated by reference herein.

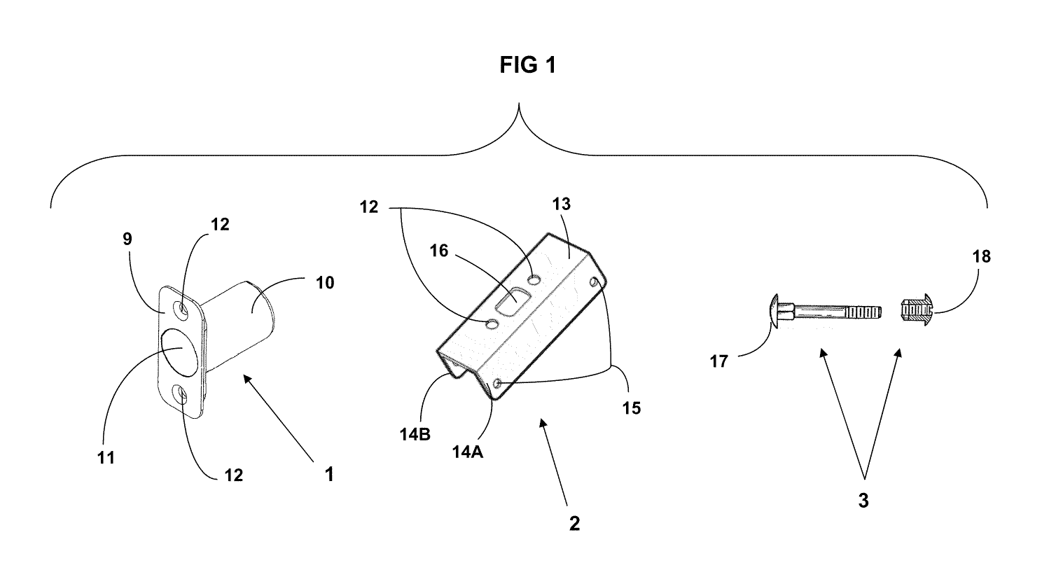

Turning now to FIG. 1, as well as FIG. 5 for an assembly view, a preferred embodiment of the present invention is shown to comprise several components which operate between a door and its casing in order to provide enhanced security against an attempted breach of the door. Specifically, a deadbolt reinforcement assembly is provided, comprising a deadbolt reinforcement cylinder 10 adapted to receive a deadbolt assembly 34, wherein the deadbolt reinforcement cylinder 10 includes a face plate 9, wherein the deadbolt reinforcement cylinder 10 is positioned within a deadbolt bore 32 of the door 30, and wherein the face plate 9 is secured to the door 30 by a plurality of fasteners 8, as will be further explained below.

The reinforcement cylinder 10 and face plate 9 are covered by a door reinforcement plate 2 having a front plate 13 with a deadbolt hole 16. The front plate 13 includes a first flange 14A extending from the front plate 13 over the interior face of the door 30, and a second flange 14B extending from the front plate 13 over the exterior face of the door 30. Each of the first and second flanges 14A, 14B includes a plurality of mounting holes 15. The door reinforcement plate 2 is secured to the door 30 by at least two door reinforcement fasteners 3, wherein each of the door reinforcement fasteners 3 is inserted through the mounting holes 15 aligned between the first and second flanges 14A, 14B and through a bolt hole 33 formed in the door 30. In practice, the bolt holes 33 will be formed by using the mounting holes 15 as a guide to ensure a tight fit onto the door 30. Each of the door reinforcement fasteners 3 will typically include a bolt 17 secured by a threaded nut 18 having means to accept the desired screwdriver bit, e.g. Phillips, flat head, etc. Preferably, each of the door reinforcement bolts 17 is inserted from the exterior side of the door, and wherein each of the bolts 17 includes a smooth head to prevent disassembly from the exterior side of the door 30.

Ideally, the deadbolt hole 16 of the door reinforcement plate 2 is shaped and dimensioned to permit slidable passage of a deadbolt from the deadbolt assembly 34, but wherein the deadbolt hole 16 is closely matched to the shape and size of the deadbolt. Closely matching the size and shape of the hole 16 to the deadbolt further provides support for the deadbolt, in addition to the assembly's own face plate, and resistance to lateral movement during an attempted breach.

As suggested above, and in view of the assembly shown in FIG. 5, the face plate 9 of the deadbolt reinforcement cylinder 10 preferably includes face plate mounting holes 12 aligned with mounting holes on the deadbolt assembly. Thus, when these components of the invention are fully assembled, the fasteners 8 are used to secure three items to the end face of the door 30, namely the deadbolt reinforcement cylinder 10 with its face plate 9, the actual deadbolt assembly 34, and the door reinforcement plate 2. As can be appreciated, when the door reinforcement fasteners 3 are installed through the flanges 14A, 14B, the deadbolt assembly 34 is now quite securely mounted within the door 30, such that any lateral force applied to the door 30 will substantially reduce the movement (and risk of failure) or both the deadbolt assembly 34 and the door 30 itself. Moreover, the reinforcement plate 2 with its strongly secured flanges 14A, 14B add structure to the door 30 at its most vulnerable point during an attempted breach, thus minimizing the possibility of breakage or splintering the door 30. This assembly is suitable for any solid wooden door 30, but even stronger when steel covered doors are employed.

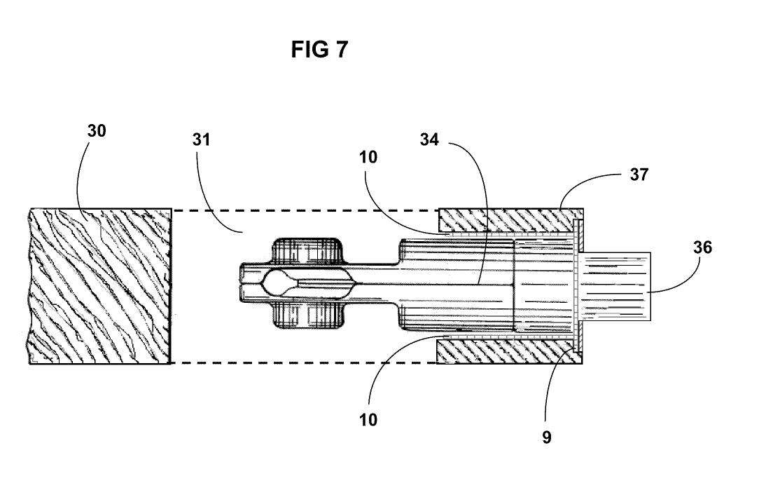

During assembly of the components described herein, it is necessary to deepen the door end face recess within which the face plate of the deadbolt assembly 34 resides, because it is desirable that the face plate 9 of the reinforcement cylinder 10 mounts flush with the end face of the door 30. When that is accomplished, the material thickness of the door reinforcement plate 2 should not interfere with the fit of the door 30 within its casing. This configuration is illustrated in the top sectional view of FIG. 7, with the door reinforcement plate 2 omitted for clarity.

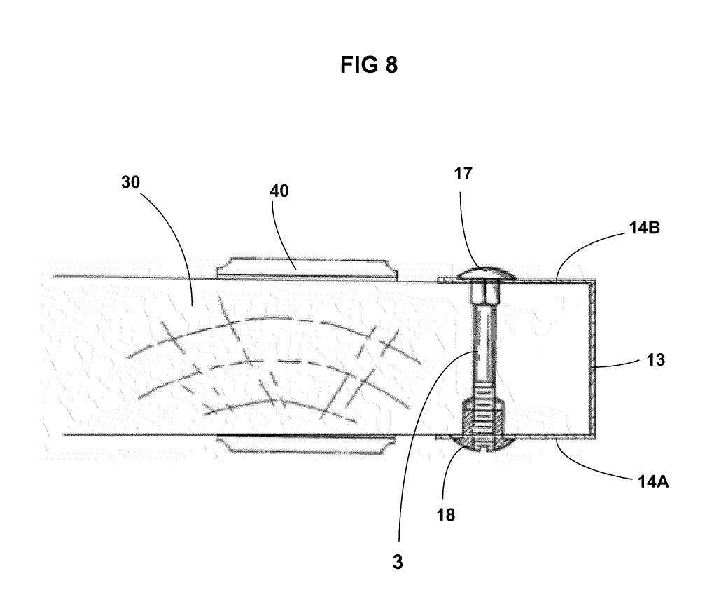

As can be appreciated, the foregoing assembly does not change the manner in which the deadbolt assembly 34 operates within the door 30, because the operating mechanism remains aligned within the deadbolt basket 31 of the door 30. Likewise, as further illustrated in FIG. 8, the flanges 14A, 14B of the door reinforcement plate 2 do not obstruct the deadbolt basket 31, and normal mounting of the door knob is unaffected.

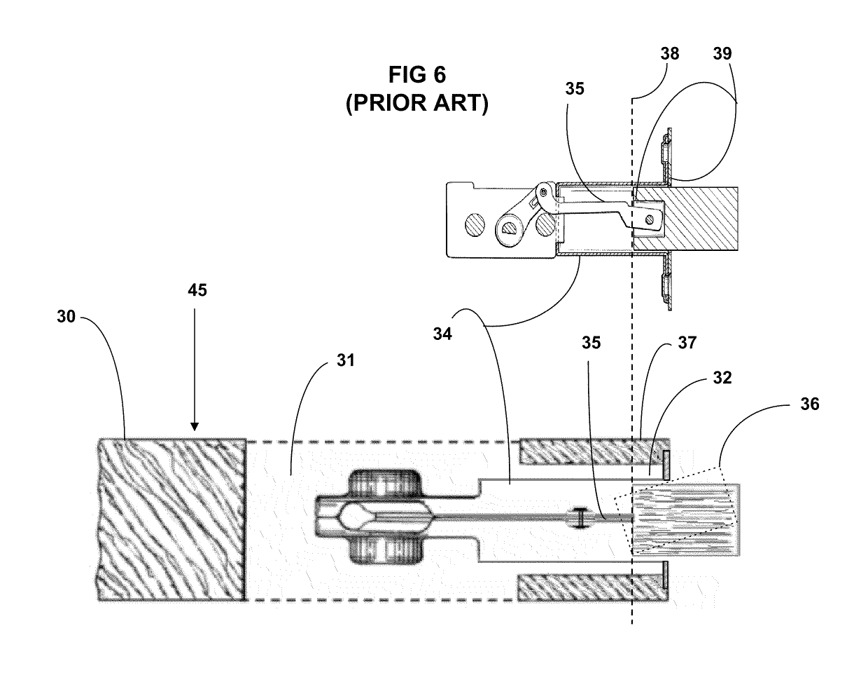

The advantages of the present invention are best understood in comparison to existing or prior art assemblies, such as the sectional views shown in FIG. 6, which depicts a standard deadbolt assembly 34 mounted in the conventional manner. Weak points in the prior art assembly allow the deadbolt 36 to pivot under impact pressure due to a breach attempt applied to the door 30 along force vector 45. Because of the design of conventional deadbolt assemblies 34, the deadbolt linkage 35 is a source of weakness, compounded by the fact that only about ¼″ of the deadbolt 36 is actually in the door. This distance can be seen between the phantom line 38 and the mounting plate 39. Furthermore, the door edge 37 is a weak point, because the typical 1″ deadbolt bore 32 only leaves about a ⅜″ strip of wood on either side of the deadbolt bore 32, which can allow that area to split and separate. Thus, upon a breach attempt along force vector 45, the deadbolt 36 is caused to pivot against the face plate 39 due to the weak point of the deadbolt linkage 35. Even if the deadbolt 36 does not pivot from the casing, the weakened door edges 37 may fail in response to the force 45.

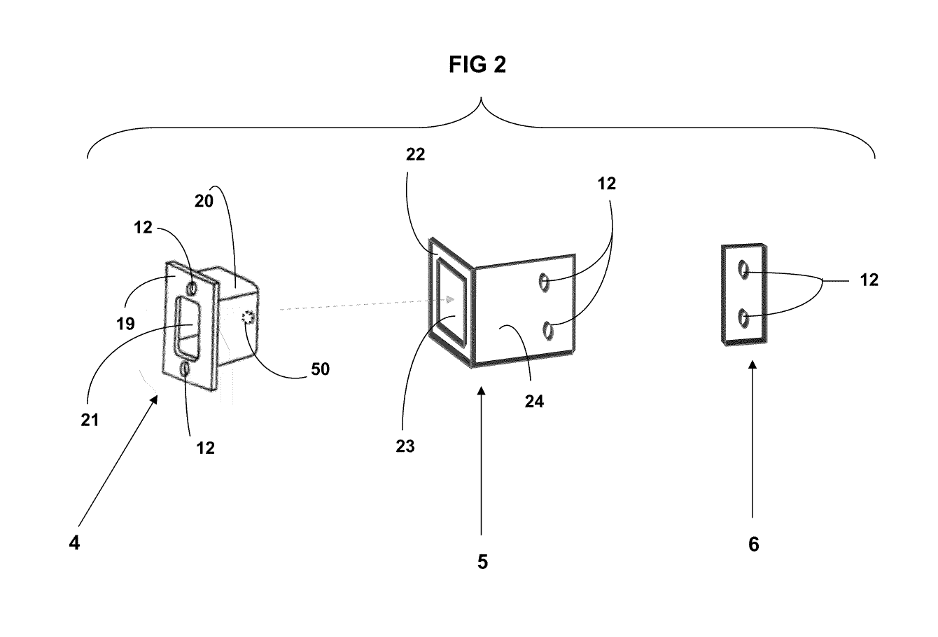

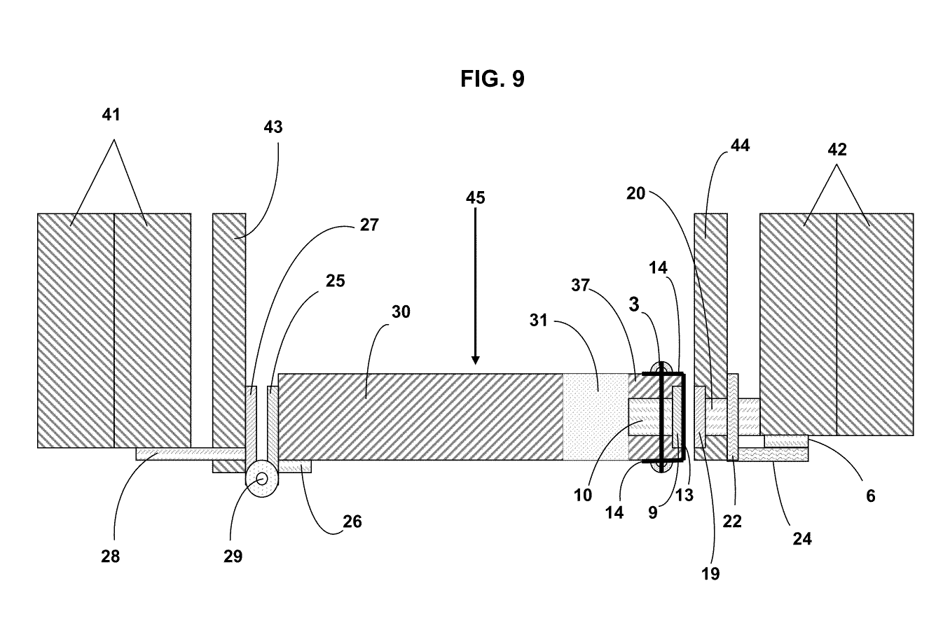

As stated above, this invention has its greatest utility when used in combination with my prior inventions disclosed in U.S. Pat. No. 7,520,544 and U.S. Pat. No. 5,570,917, the disclosures of which are incorporated herein by reference. Specifically, and with regard to FIG. 2 and FIG. 9, a deadbolt striker plate assembly 4 can be employed, which comprises a deadbolt striker face plate 19 and an enclosed housing 20 adapted to receive a deadbolt 36 into cavity 21 from the deadbolt assembly 34. The striker face plate 19 is attached to a door casing 44 by standard fasteners through mounting holes 12. Optionally, an additional nail or screw may be used through hole 50 in the rear of the housing 20 to secure the housing 20 to the wall stud 42.

A reinforcing member 5 comprises a first flange 22 parallel to the striker face plate 19, and having an opening 23 adapted to matably and interlockingly surround and engage the deadbolt housing 20, and a second flange 24 perpendicular to the first flange 22 having a first hole pattern 12. As illustrated in FIG. 9, the second flange of the reinforcing member 5 is attached to a wall stud 42, typically by standard fasteners. Depending upon the specific situation, a suitably sized shim 6 may also be employed to align the components properly.

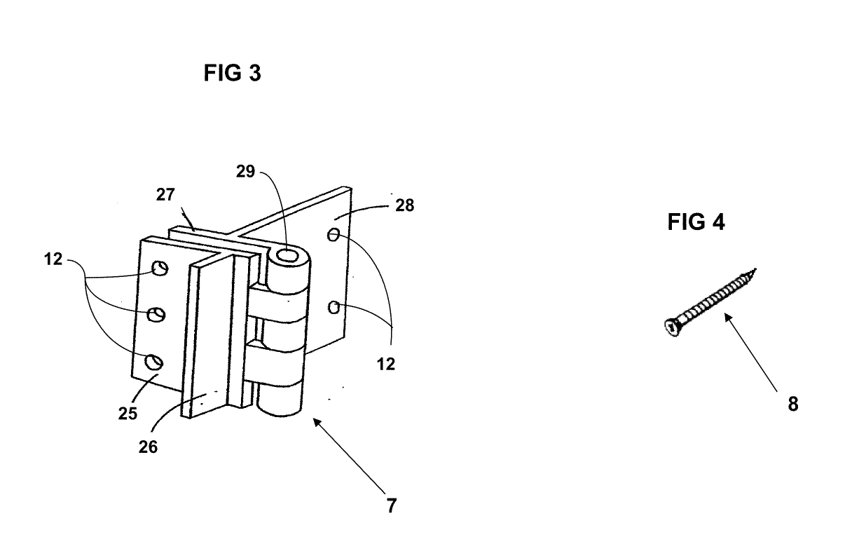

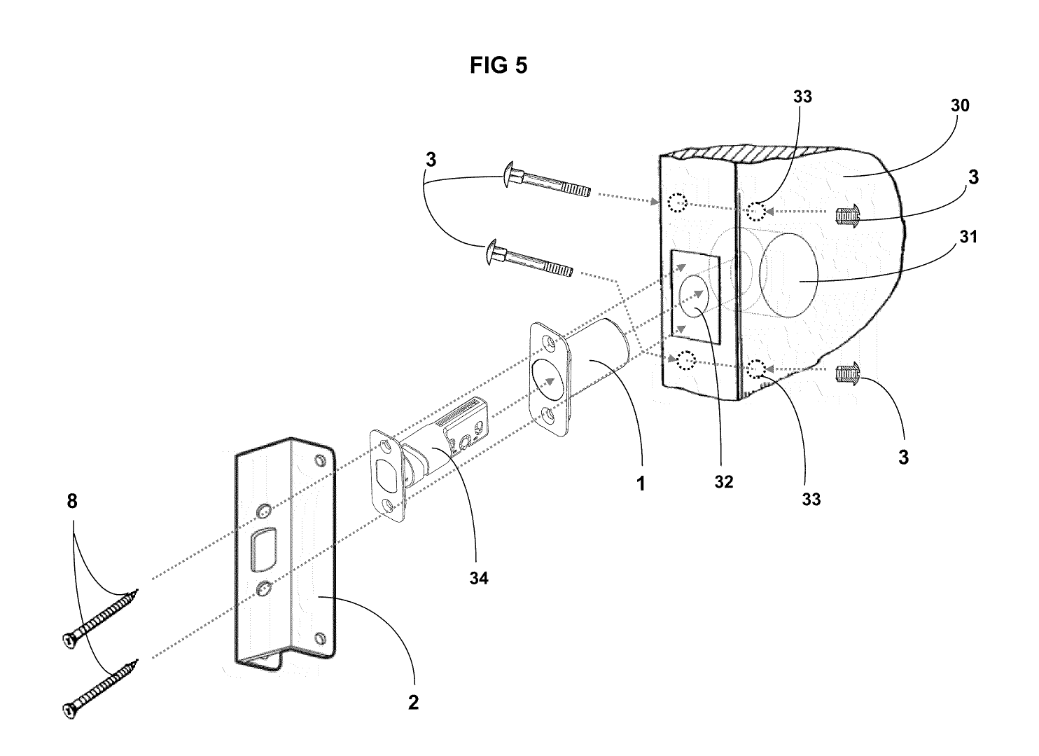

Furthermore, as illustrated in FIG. 3 and FIG. 9, on the hinge side of the door 30, the entrance door security system further includes at least one security hinge assembly 7 connected between the door 30, the door casing 43, and an interior wall structure 41 (such as wall studs 42). Preferably, as least one such security hinge assembly 7 would be employed for maximum strength and effectiveness. The security hinge assembly 7 comprises first and second hinging plates 25, 27 operatively connected by a pin 29. The first hinging plate 25 is attached to the door 30 and includes a backstop plate 26. The backstop plate 26 can prevent dislodgement of the fasteners 8 connecting the plate 25 to the door 30 during a breach attempt along force vector 45. Similarly, the second hinging plate 27 includes an anchoring plate 28 attached to the interior wall structure 41. The security hinge assembly 7 is much stronger than conventional door hinges, because it provides direct reinforcement along planes which are perpendicular to the applied force vector 45. When they are used in combination with the other components described and claimed herein, the overall system provides protection against breaches that is far superior to conventional door hardware.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. In a door having an end face, an exterior face, and an interior face, a deadbolt reinforcement assembly, comprising:
(a) a deadbolt reinforcement cylinder adapted to receive a deadbolt assembly, wherein the deadbolt reinforcement cylinder includes a face plate, wherein the deadbolt reinforcement cylinder is positioned within a deadbolt bore of the door, and wherein the face plate is secured to the door by a plurality of fasteners;
(b) a door reinforcement plate having a front plate with a deadbolt hole, and including a first flange extending from the front plate over the interior face of the door, and a second flange extending from the front plate over the exterior face of the door, wherein each of the first and second flanges includes a plurality of mounting holes; and
(c) one or more door reinforcement bolts, wherein each of the door reinforcement bolts is inserted through the mounting holes aligned between the first and second flanges and through a bolt hole formed in the door, and wherein each of the door reinforcement bolts is secured by a threaded nut.

2. The assembly of claim 1, wherein the face plate of the deadbolt reinforcement cylinder includes face plate mounting holes aligned with mounting holes on the deadbolt assembly.

3. The assembly of claim 1, wherein the deadbolt hole of the door reinforcement plate is shaped and dimensioned to permit slidable passage of a deadbolt, but wherein the deadbolt hole is closely matched to the shape and size of the deadbolt.

4. The assembly of claim 1, wherein the front plate of the door reinforcement plate includes mounting holes aligned with mounting holes on the deadbolt assembly.

5. The assembly of claim 1, wherein each of the door reinforcement bolts is inserted from the exterior side of the door, and wherein each of the bolts includes a smooth head to prevent disassembly from the exterior side of the door.

6. In a door having an end face, an exterior face, and an interior face, an entrance door security system, comprising:
(a) deadbolt reinforcement assembly, wherein the deadbolt reinforcement assembly comprises:
a deadbolt reinforcement cylinder adapted to receive a deadbolt assembly, wherein the deadbolt reinforcement cylinder includes a face plate, wherein the deadbolt reinforcement cylinder is positioned within a deadbolt bore of the door, and wherein the face plate is secured to the door by a first plurality of fasteners;
a door reinforcement plate having a front plate with a deadbolt hole, and including a first flange extending from the front plate over the interior face of the door, and a second flange extending from the front plate over the exterior face of the door, wherein each of the first and second flanges includes a plurality of mounting holes; and
one or more door reinforcement bolts, wherein each of the door reinforcement bolts is inserted through the mounting holes aligned between the first and second flanges and through a bolt hole formed in the door, and wherein each of the door reinforcement bolts is secured by a threaded nut; and
(b) a deadbolt striker plate assembly, comprising:
a deadbolt striker plate having a striker face plate and an enclosed housing adapted to receive a deadbolt from the deadbolt assembly, wherein the striker face plate is attached to a door casing by a second plurality of fasteners; and
a reinforcing member comprising a first flange parallel to the striker face plate having an opening adapted to matably and interlockingly surround and engage the housing of the deadbolt striker plate, and a second flange perpendicular to the first flange having a first hole pattern, wherein the second flange of the reinforcing member is attached to a wall stud by a third plurality of fasteners.

7. The system of claim 6, further including at least one security hinge assembly connected between the door, the door casing and an interior wall structure, wherein the security hinge assembly comprises first and second hinging plates operatively connected by a pin, wherein the first hinging plate is attached to the door and includes a backstop plate; and wherein the second hinging plate includes an anchoring plate attached to the interior wall structure.

8. The system of claim 6, wherein the deadbolt striker plate assembly further includes a shim plate having a second hole pattern adapted to matably engage the first hole pattern of the second flange of the reinforcing member, and wherein the first hole pattern comprises at least two holes adapted to receive mounting screws.

9. The system of claim 6, wherein face plate of the deadbolt reinforcement cylinder includes face plate mounting holes aligned with mounting holes on the deadbolt assembly.

10. The system of claim 6, wherein the deadbolt hole of the door reinforcement plate is shaped and dimensioned to permit slidable passage of a deadbolt, but wherein the deadbolt hole is closely matched to the shape and size of the deadbolt.

11. The system of claim 6, wherein the front plate of the door reinforcement plate includes mounting holes aligned with mounting holes on the deadbolt assembly.

12. The system of claim 6, wherein each of the door reinforcement bolts is inserted from the exterior side of the door, and wherein each of the bolts includes a smooth head to prevent disassembly from the exterior side of the door.
